(19) United States
(12) Patent Application Publication
(10) Pub. No.: US 2015/0312303 A1
(43) Pub. Date: Oct. 29, 2015

(54) DETERMINING WHETHER TO USE SIDX INFORMATION WHEN STREAMING MEDIA DATA

(71) Applicant: QUALCOMM Incorporated, San Diego, CA (US)

(72) Inventors: Arvind Subramanian Krishna, San Diego, CA (US); Praveen Kota, San Diego, CA (US); Deviprasad Putchala, San Diego, CA (US)

(73) Assignee: QUALCOMM Incorporated, San Diego, CA (US)

(21) Appl. No.: 14/262,023

(22) Filed: Apr. 25, 2014

(51) Int. Cl. H04L 29/06

(52) U.S. Cl. CPC H04L 65/602; H04L 65/80

(57) ABSTRACT

A device for retrieving media data includes one or more processors configured to determine, for a segment of a representation of media data, whether to use segment index (SIDX) information of the segment, and in response to determining not to use the SIDX information, retrieve media data of the segment without using the SIDX information of the segment. The processors may determine whether to retrieve the SIDX information based on a determination of whether the segment includes SIDX information and/or based on a playback duration of the segment.

### TECHNICAL FIELD

This disclosure relates to transport of encoded video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for determining whether to use segment index (SIDX) information of a segment of a representation of media data. The SIDX information may generally describe sub-segments of the segment, e.g., byte ranges corresponding to the sub-segments, such that the sub-segments can be accessed easily by a client device. The client device may be configured to determine whether to use SIDX information, e.g., when performing a random access event, such as switching between representations or performing a seek operation. In some examples, the client device may determine whether the SIDX information is present in a segment, and determine to use the SIDX information only when the SIDX information is present. Additionally or alternatively, even when SIDX information is present, the client device may determine whether to use the SIDX information based on, e.g., a playback duration of the segment.

In one example, a method of retrieving media data includes determining, for a segment of a representation of media data, whether to use segment index (SIDX) information of the segment, and in response to determining not to use the SIDX information, retrieving media data of the segment without using the SIDX information of the segment.

In another example, a device for retrieving media data includes one or more processors configured to determine, for a segment of a representation of media data, whether to use segment index (SIDX) information of the segment, and in response to determining not to use the SIDX information, retrieve media data of the segment without using the SIDX information of the segment.

In another example, a computer-readable storage medium has stored thereon instructions that cause a processor of a destination device for receiving encapsulated video data to determine, for a segment of a representation of media data, whether to use segment index (SIDX) information of the segment, and, in response to determining not to use the SIDX information, retrieve media data of the segment without using the SIDX information of the segment.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a conceptual diagram illustrating elements of example multimedia content.

FIG. 3 is a block diagram illustrating elements of an example video file, which may correspond to a segment of a representation.

FIGS. 4 and 5 are flowcharts illustrating an example method for retrieving data of a segment in accordance with the techniques of this disclosure.

### DETAILED DESCRIPTION

In general, this disclosure describes techniques for improving the use of segment index (SIDX) information (i.e., SIDX data) when streaming media data. In general, the techniques of this disclosure may be applied to media data (or other data to be streamed) that is organized into segments encapsulated within respective media files. Each segment may include SIDX information (also referred to as SIDX data) that defines sub-segments of the segment. For instance, the SIDX information may define locations (either or both in terms of playback location and in terms of byte location) of sub-segments within the segment. The SIDX information, or other data for the segment, may further indicate whether a particular sub-segment includes a stream access point (SAP). With respect to video data, for example, a SAP may correspond to a random access point (RAP), such as an instantaneous decoder refresh (IDR), clean random access (CRA), broken link access (BLA), or other such picture.

The techniques of this disclosure may be applied to media files conforming to media data encapsulated according to any of ISO base media file format, Scalable Video Coding (SVC) file format, Advanced Video Coding (AVC) file format, Third Generation Partnership Project (3GPP) file format, and/or Multiview Video Coding (MVC) file format, or other similar video file formats. Furthermore, the techniques of this disclosure may be used in conjunction with a streaming protocol, such as dynamic adaptive streaming over HTTP (DASH). DASH is described in, e.g., 3rd Generation Partnership Project, Technical Specification Group Services and System Aspects, Transparent end-to-end Packet-switched Streaming Service (PSS), Progressive Download and Dynamic Adaptive Streaming over HTTP (3GP-DASH) (Release 12), 3GPP TS 26.247 V12.1.0, December 2013, available at http://www.3gpp.org/DynaReport/26247.htm and http://www.3gpp.org/ftp/Specs/archive/26_series/26.247/26247-c10.zip. DASH does not mandate the presence of SIDX information in a segment. That is, in a media file for DASH, SIDX information is optional. Thus, in some examples, the techniques of this disclosure include determining whether a media file, e.g., a video file, includes SIDX information, and only using the SIDX information when the file is determined to include the SIDX information.

More generally, the techniques of this disclosure include determining whether to use SIDX information, and only using the SIDX information after determining to use the SIDX information. For example, as discussed above, determining whether to use SIDX information may include determining whether the SIDX information is present in a media file. In response to determining that SIDX information is not present, a client device retrieving media data may enter a “no SIDX present” mode, in which the client device avoids determining whether subsequent segments of the same media content include SIDX information. For instance, the client device may simply request the entire segment, rather than attempting to use SIDX information to retrieve sub-segments of the segment.

Alternatively, the client device may determine not to use SIDX information even if the SIDX information is present in a particular segment. For instance, the client device may be defined with a particular playback duration that defines a threshold for using SIDX information. For a segment having a playback duration less than or equal to the threshold, the client device may avoid using the SIDX information to retrieve data of the segment, but may instead simply retrieve the entire segment. Alternatively, for a segment having playback duration greater than the threshold, the client device may attempt to use SIDX information to retrieve sub-segments of the segment.

Typically, a client device may determine whether or not to use SIDX information of a segment in response to performing a random access event. For instance, when the client device switches from one representation to another, the client device may determine whether to switch at a segment boundary (e.g., when not using SIDX information) or at a sub-segment boundary (e.g., when attempting to use SIDX information). Alternatively, the client device may perform a seek operation to playback content form a new temporal location (that is, playback location) within the same representation (or a different representation), and perform the techniques of this disclosure to determine whether to use or not use SIDX information when performing the seek operation.

As noted above, the DASH standard provides an optional SIDX box that describes switch points within a larger segment. This enables client devices to perform random access, e.g., switch between representations, at sub-segment boundaries, as opposed to larger segment boundaries. The SIDX box may also provide other information, such as random access point (RAP) position, duration, and sizes of sub-segments that are used by client devices in switch determinations. Though SIDX information is useful, it adds overhead in terms of post processing necessary to generate this information. This adds to content availability time for the live streaming case affecting end-to-end latency. The DASH specification therefore leaves it up to the individual deployments to determine whether to add SIDX information.

Furthermore, the availability of SIDX information itself is not part of the media presentation description (MPD), nor can it be inferred via other means. It is possible to determine the presence of SIDX information only in the case of MPEG2-TS simple live, as the SIDX information is available at a separate URL. The only way for a client device to determine whether the SIDX information is available is for the client device to download actual data and figure this out. Thus, this presents a technical challenge for a client device. In accordance with the techniques of this disclosure, a client device may intelligently detect and adapt media download behavior based on the availability of SIDX information.

The techniques of this disclosure may include the use of the following pseudocode-defined algorithm to detect the presence of SIDX information:

For each adaptation set:
when there is a SIDX determination event (described later), the client device issues a separate GET request to read SIDX information (if not already downloaded locally) to the server
   If SIDX is present:
      for (adaptation set, rep) pair, the client device enters download-SIDX mode
   If SIDX is not present:
      for (adaptation set, rep) pair, the client device enters download-noSIDX mode

In the download-SIDX mode (which may also be referred to as a SIDX-present mode), the client device may operate on sub-segment boundaries by first downloading SIDX information, parsing the SIDX information, and downloading sub-segments, as opposed to entire segments. This behavior involves at least two partial GET requests to download a segment, but allows the client device to adapt quicker (e.g., to bandwidth fluctuations).

In the download-noSIDX mode (which may also be referred to as a no-SIDX-present mode), the client device may operate on segment boundaries and may download the entire segment via one GET request. This allows client devices to pipeline data requests and increase throughput of download. While parsing downloaded data, if the client device detects the presence of SIDX information, then the client device may switch to download-SIDX mode for the adaptation set representation combination.

Client devices may perform SIDX determination events at various times. For example, client devices may perform SIDX determination events at startup, at a bit rate change, at adaptation set ADD/REPLACE operations for new adaptation sets, at SEEK events by a user, and/or at period boundaries. Likewise, client devices may perform SIDX determinations periodically, e.g., at configurable time intervals.

By implementing one or more of the techniques of this disclosure, client devices may be capable of dynamically detecting and adapting data retrieval behavior, depending on the presence/absence of SIDX information. This may allow the client devices to optimize download behavior (e.g., by sending one HTTP GET request versus two partial GET requests) based on SIDX information. Furthermore, the techniques of this disclosure work when different sources, which independently add and/or remove SIDX information, provide content of either different representations within the same adaptation set or different adaptation sets. These techniques allow adaptation even for cases where SIDX information is not initially present, and then is added during media presentation by a content provider. For non-switchable adaptation sets (that is, adaptation sets that include only one representation or when a client device cannot perform rate adaptation, e.g., due to hardware limitations of the client device), these techniques may optimize download operations. These techniques may be applied for ISO base media file format, live, video on demand (VOD), and MPEG2-TS profiles and for Live and VOD scenarios (e.g., for static or dynamic content).

In HTTP streaming, frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, such as DASH, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more periods. Periods may be defined by a Period element in the MPD. Each period may have an attribute start in the MPD. The MPD may include a start attribute and an availableStartTime attribute for each period. For live services, the sum of the start attribute of the period and the MPD attribute availableStartTime may specify the availability time of the period in UTC format, in particular the first Media Segment of each representation in the corresponding period. For on-demand services, the start attribute of the first period may be 0. For any other period, the start attribute may specify a time offset between the start time of the corresponding Period relative to the start time of the first Period. Each period may extend until the start of the next Period, or until the end of the media presentation in the case of the last period. Period start times may be precise. They may reflect the actual timing resulting from playing the media of all prior periods.

Each period may contain one or more representations for the same media content. A representation may be one of a number of alternative encoded versions of audio or video data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

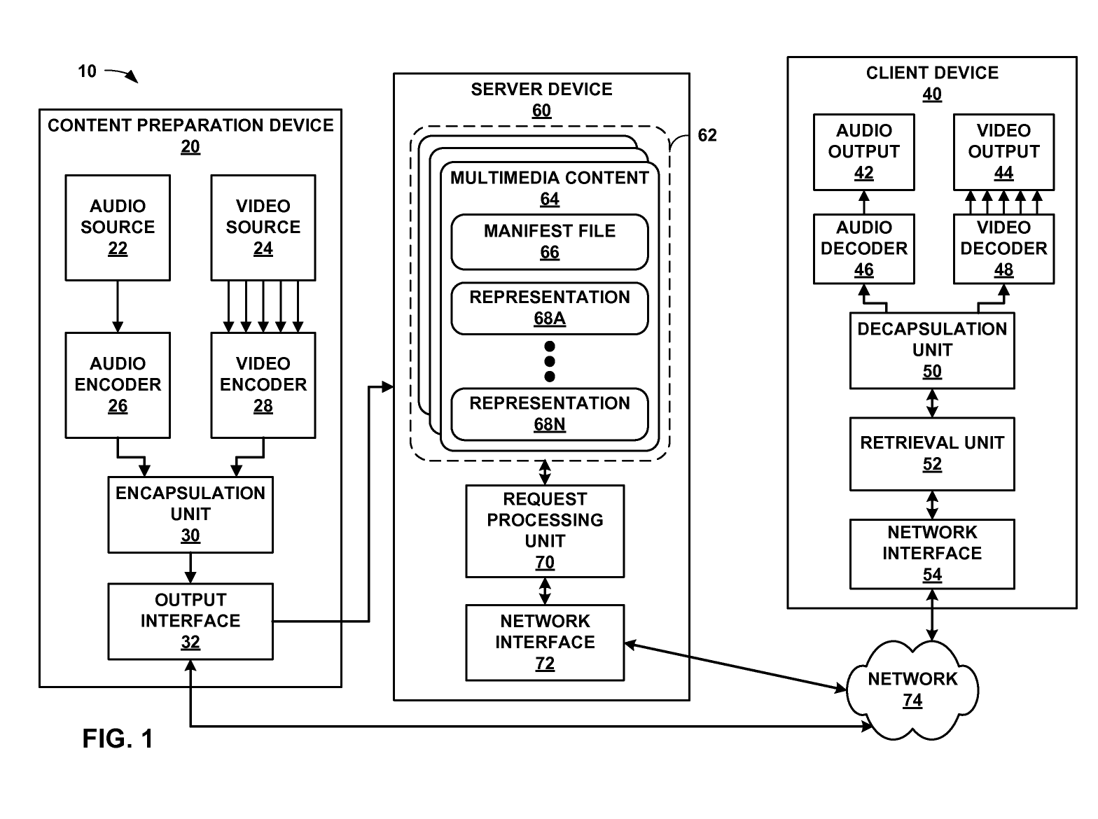

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the upcoming High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. In the example of H.264/AVC (Advanced Video Coding), coded video segments are organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture, hence coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Retrieval unit 52 may be configured to retrieve media data (e.g., audio and/or video data), e.g., using DASH. In accordance with the techniques of this disclosure, retrieval unit 52 may be configured to determine whether to use segment index (SIDX) information of segments. For instance, retrieval unit 52 may determine whether segments include SIDX information, and to only use SIDX information of the segments when the segments include the SIDX information. To determine whether SIDX information is present, retrieval unit 52 may send an HTTP partial GET request that specifies a byte range of a segment corresponding to an estimated location of the SIDX information.

Furthermore, in some examples, retrieval unit 52 may determine whether the SIDX information would be beneficial to use, or not, even if present. For instance, retrieval unit 52 may determine whether a segment has a playback duration that is less than a threshold (e.g., 2 seconds), and if so, to avoid using SIDX information of the segment, even if the SIDX information is present. That is, retrieval unit 52 may be configured to use the SIDX information only if the segment in question has a playback duration that is greater than the threshold. Although a threshold of 2 seconds is described for purposes of example, the threshold may be defined according to other values as well, e.g., one second, one half of one second, or generally any time in the range of one half of one second to ten seconds.

Retrieval unit 52 may generally apply the techniques of this disclosure (e.g., with respect to determining whether SIDX information should be used) when performing a random access event. A random access event may include, for example, switching between representations in response to a change in available network bandwidth and/or seeking to a new temporal location (that is, a new playback time).

Furthermore, retrieval unit 52 may be configured to apply the techniques of this disclosure in order to perform data pipelining. As noted above, the techniques of this disclosure may be used in conjunction with the Live profile of DASH. An example, conventional technique for retrieving data in accordance with the Live profile of DASH is summarized below:
At startup, a streaming application (not shown in FIG. 1, but which may correspond to a web browser or plugin to a web browser, executed by one or more processing units of FIG. 1, also not shown) issues a metadata request for an adaptation set from presentation time 0-1 seconds.
Retrieval unit 52 fetches SIDX information from server device 60 and returns the appropriate segments/sub-segments that correspond to this duration to the streaming application. In the present example, this corresponds to segment #0 from time 0-2 seconds.
   In the case where there is no SIDX information present, retrieval unit 52 may internally generate the SIDX information from MPD parameters
   In some examples, the streaming application needs metadata prior to issuing a data download
The streaming application then issues a request to download data for segment #0. At some point, when the next segment becomes available at the server, the application then issues a GET request to download SIDX for playback time 2-4 seconds
As there is an ongoing data download, this request is submitted on top of the current data download and is serviced after completion of the current data download request. Therefore, the second data request cannot be pipelined on top of the first data download request (as there is a sidx request in between).
   Additionally there is a minimum of two HTTP GET requests needed to download each segment in the live profile.

This conventional download behavior may encounter two limitations. First, data downloads cannot be pipelined. In addition, two GET requests are needed for downloading each segment. The techniques of this disclosure may be used to improve download behavior for the Live profile of DASH, as described in greater detail below. In general, the techniques of this disclosure may allow a client device to pipeline requests for media data, e.g., using SIDX information.

In ISO base media file format, a segment may be a single movie fragment without SIDX data. Furthermore, in ISO base media file format, representations need not be multiplexed, and each segment may begin with a SAP. In MPEG-2 TS (Transport Streams), a segment need not include SIDX information, each segment may begin with a SAP for each elementary stream, and bitstream switching may be enabled. That is, for MPEG-2 TS, switching can be effected by concatenating segments from different representations. Such examples are common deployment scenarios for streaming of live media data.

As these common deployment scenarios do not include SIDX information, there is no need for retrieval unit 52 to issue a metadata request over the network to fetch actual SIDX information, contrary to the conventional retrieval techniques summarized above. Instead, retrieval unit 52 may infer SIDX information locally, based on MPD parameters. The metadata structure conveyed to the streaming application may be populated as follows:
RAP information: use @segmentStartsWithRAP (this is always true for the supported profiles)
Segment duration: inferred from duration parameter in MPD
Segment size in bytes: use representation rate*duration.
Key information: generated locally by retrieval unit 52

In accordance with the techniques of this disclosure, once the streaming application receives the metadata, the streaming application may immediately issue data download requests. This allows for data pipelining. Because retrieval unit 52 infers the SIDX information locally in the above example, and the SIDX information includes the nominal size information, retrieval unit 52 may use open-ended byte range requests to download the entire segment. This is may be done as part of the no-SIDX-present mode described above.

In some examples, the streaming application may be configured to conditionally infer metadata information, such as the metadata discussed above. For example, rather than always inferring SIDX information, the streaming application may conditionally infer SIDX information. The process for inferring SIDX, as discussed above, may only be used for shorter duration segments, in some examples. For these segments, downloading SIDX information may be less valuable and operating at the segment boundary (as opposed to the sub segment boundary) would not impact performance/behavior adversely. A configurable threshold parameter, Sidx_Infer_Threshold, may be used to determine whether to use inferred or actual SIDX information. Additionally, even in the case where segment durations are more than the threshold, SIDX information may be inferred for non-switchable adaptation sets (such as audio and text). For video/multiplexed adaptation sets, a remote SIDX request may be issued if a playback duration is above the threshold value. Examples are summarized below:
If an adaptation set is non-switchable (e.g., because the adaptation set only includes one representation or because a client device is only able to use one representation of the adaptation set, e.g., due to hardware limitations), always infer metadata
If segment duration is greater than Sidx_Infer_Threshold, use actual metadata
   else, infer metadata

In some cases, there may be adversarial scenarios where there is no SAP (e.g., RAP) at the start of a segment. In this case, a switch may still occur, because the SIDX information may be inferred locally, and a RAP frame is assumed to exist. Certain supported profiles mandate a RAP at the start of a segment. There are two approaches to handle this:
Retrieval unit 52 infers that a SIDX information request is for rate reselection. This may be done via internal switch point information structure of retrieval unit 52. If true, the source may retrieve the actual metadata, even if the segment duration is below the inference threshold.
Alternatively, there may be an additional parameter (e.g., Boolean DownloadData(Boolean downloadSidx), defining a Boolean value) in a RequestNumberDataUnitslnfo( ) API call from the streaming application to retrieval unit 52. This parameter by default is set to false and may be set to true by the streaming application when the SIDX information request is initiated for a rate reselection. If this parameter is true, retrieval unit 52 may obtain actual metadata.

Sidx_Infer_Threshhold may be set to 2 seconds, in some examples. Retrieval unit 52 may provide the ability to configure this value via, e.g., an HTTP properties configuration file. This configuration may be performed for parameter tuning purposes. Retrieval unit 52 may also log the determination of whether to infer or request actual SIDX information for post-processing.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264 /AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium 34, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

In this manner, client device 40 represents an example of a device for retrieving media data, the device including one or more processors configured to determine, for a segment of a representation of media data, whether to use segment index (SIDX) information of the segment, and in response to determining not to use the SIDX information, retrieve media data of the segment without using the SIDX information of the segment.

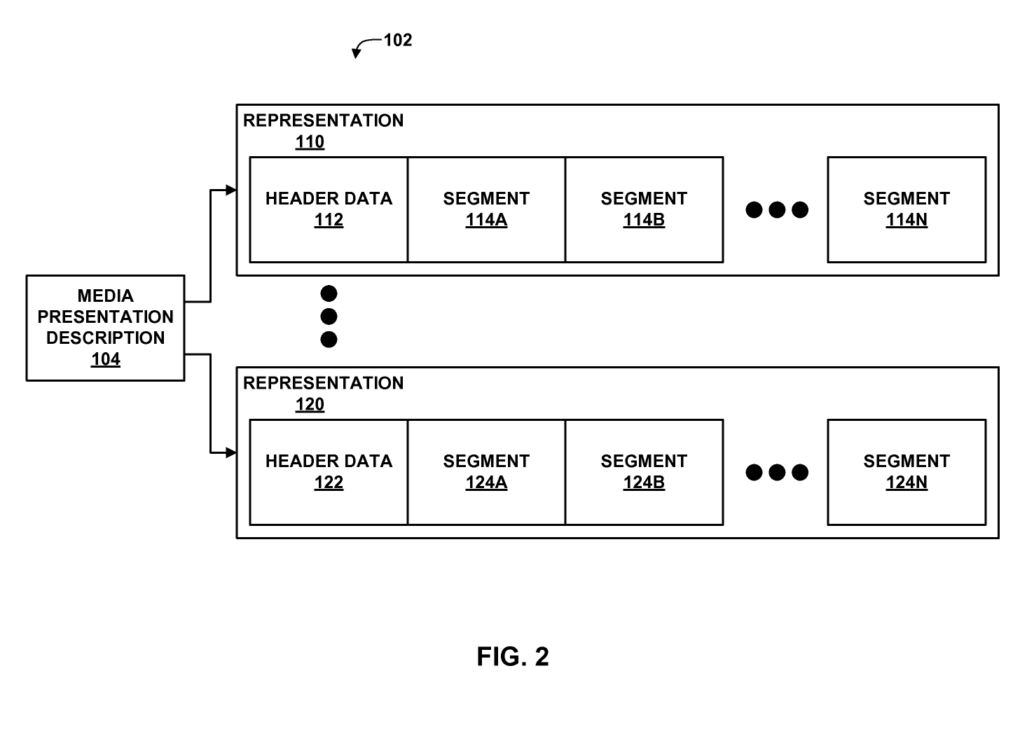

FIG. 2 is a conceptual diagram illustrating elements of example multimedia content 102. Multimedia content 102 may correspond to multimedia content 64 (FIG. 1), or another multimedia content stored in memory 62. In the example of FIG. 2, multimedia content 102 includes media presentation description (MPD) 104 and a plurality of representations 110-120. Representation 110 includes optional header data 112 and segments 114A-114N (segments 114), while representation 120 includes optional header data 122 and segments 124A-124N (segments 124). The letter N is used to designate the last movie fragment in each of representations 110, 120 as a matter of convenience. In some examples, there may be different numbers of movie fragments between representations 110, 120.

MPD 104 may comprise a data structure separate from representations 110-120. MPD 104 may correspond to manifest file 66 of FIG. 1. Likewise, representations 110-120 may correspond to representations 68 of FIG. 1. In general, MPD 104 may include data that generally describes characteristics of representations 110-120, such as coding and rendering characteristics, adaptation sets, a profile to which MPD 104 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 112, when present, may describe characteristics of segments 114, e.g., temporal locations of random access points (RAPS, also referred to as stream access points (SAPs)), which of segments 114 includes random access points, byte offsets to random access points within segments 114, uniform resource locators (URLs) of segments 114, or other aspects of segments 114. Header data 122, when present, may describe similar characteristics for segments 124. Additionally or alternatively, such characteristics may be fully included within MPD 104.

Segments 114, 124 include one or more coded video samples, each of which may include frames or slices of video data. Each of the coded video samples of segments 114 may have similar characteristics, e.g., height, width, and bandwidth requirements. Such characteristics may be described by data of MPD 104, though such data is not illustrated in the example of FIG. 2. MPD 104 may include characteristics as described by the 3GPP Specification, with the addition of any or all of the signaled information described in this disclosure. The 3GPP file format is described in 3rd Generation Partnership Project, Technical Specification Group Services and System Aspects; Transparent end-to-end packet switched streaming service (PSS); 3GPP file format (3GP) (Release 12), TS 26.244, Dec. 19, 2013, available at http://www.3gpp.org/DynaReport/26244.htm.

Each of segments 114, 124 may be associated with a unique uniform resource locator (URL). Thus, each of segments 114, 124 may be independently retrievable using a streaming network protocol, such as DASH. In this manner, a destination device, such as client device 40, may use an HTTP GET request to retrieve segments 114 or 124. In some examples, client device 40 may use HTTP partial GET requests to retrieve specific byte ranges of segments 114 or 124.

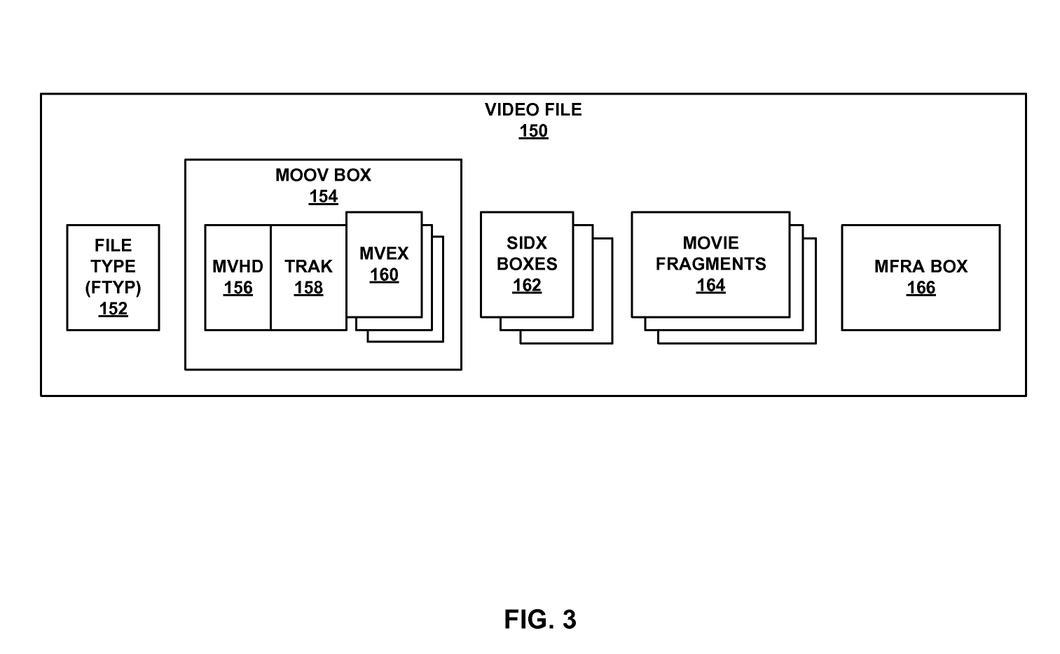

FIG. 3 is a block diagram illustrating elements of an example video file 150, which may correspond to a segment of a representation, such as one of segments 114, 124 of FIG. 2. Each of segments 114, 124 may include data that conforms substantially to the arrangement of data illustrated in the example of FIG. 3. Video file 150 may be said to encapsulate a segment. As described above, video files in accordance with the ISO base media file format and extensions thereof store data in a series of objects, referred to as “boxes.” In the example of FIG. 3, video file 150 includes file type (FTYP) box 152, movie (MOOV) box 154, segment index (SIDX) boxes 162, movie fragment (MOOF) boxes 164, and movie fragment random access (MFRA) box 166. Although FIG. 3 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

In some examples, a segment, such as video file 150, may include an MPD update box (not shown) before FTYP box 152. The MPD update box may include information indicating that an MPD corresponding to a representation including video file 150 is to be updated, along with information for updating the MPD. For example, the MPD update box may provide a URI or URL for a resource to be used to update the MPD. As another example, the MPD update box may include data for updating the MPD. In some examples, the MPD update box may immediately follow a segment type (STYP) box (not shown) of video file 150, where the STYP box may define a segment type for video file 150. FIG. 7, discussed in greater detail below, provides additional information with respect to the MPD update box.

MOOV box 154, in the example of FIG. 3, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or SIDX boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units which contains the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box is used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

As noted above, video files conforming to 3GPP file format do not necessarily include SIDX boxes 162. In accordance with the techniques of this disclosure, retrieval unit 52 of client device 40 (FIG. 1) may be configured to determine whether SIDX boxes 162 are present within video file 150. For instance, retrieval unit 52 may submit an HTTP partial GET request specifying a byte range that is expected to include one or more of SIDX boxes 162. As an example, suppose that FTYP box 152 is typically N bytes long and MOOV box 154 is typically M bytes long. Retrieval unit 52 may submit at partial GET request that specifies a byte range of M+N to M+N+X, where X is a number of bytes that is expected to include at least one of SIDX boxes 162.

After receiving the requested portion of video file 150 in response to the partial GET request, retrieval unit 52, or another element of client device 40, may parse the received portion of video file 150 to determine whether the retrieved portion includes SIDX data. When the retrieved portion includes SIDX data, retrieval unit 52 may enter a SIDX present mode, in which retrieval unit 52 uses data of SIDX boxes 162, e.g., when performing a switch between representations of a common adaptation set, when performing a seek to a new playback location, or the like. On the other hand, when the retrieved portion does not include SIDX data, retrieval unit 52 may enter a no-SIDX present mode, in which retrieval unit 52 does not attempt to use data of SIDX boxes 162. For instance, when in the no-SIDX present mode, retrieval unit 52 may simply retrieve an entire segment (e.g., using a single HTTP GET request), and skip any steps including attempting to retrieve SIDX data of video file 150.

Additionally or alternatively, retrieval unit 52 may be configured to avoid using data of SIDX boxes 162 even when SIDX boxes 162 are present within video file 150. For example, retrieval unit 52 may determine a playback duration of video file 150 (or, particularly, a segment encapsulated within video file 150). Retrieval unit 52 may be configured with a defined threshold for the playback duration. Such a threshold may generally have any desired value, such as a value in the range of one half of one second to ten seconds.

Assume, for example, that the threshold is defined as two seconds. Retrieval unit 52 may determine whether the segment encapsulated by video file 150 has a playback duration less than two seconds, in this example. When the segment has a playback duration below or equal to the threshold (two seconds, in this example), retrieval unit 52 may avoid using data of SIDX boxes 162, even if SIDX boxes 162 are present in video file 150. On the other hand, when the segment has a playback duration greater than the threshold, retrieval unit 52 may use (or at least attempt to use) data of SIDX boxes 162, assuming SIDX boxes 162 are present. In some examples, retrieval unit 52 may first determine whether SIDX boxes 162 are present, e.g., using the techniques described above. Assuming that SIDX boxes 162 are present and that the playback duration is greater than the threshold, retrieval unit 52 may use data of SIDX boxes 162.

In general, using data of SIDX boxes 162 includes, when performing random access (e.g., when switching from one representation to another, when performing a seek to a new temporal location, or the like), retrieving SIDX boxes 162 and determining sub-segments of a segment encapsulated by video file 150. For instance, each of the sub-segments may comprise a respective, distinct subset of movie fragments 164. SIDX boxes 162 may define playback times (e.g., start, end, and/or playback durations) for the sub-segments, as well as byte values (e.g., raw byte values for the start and/or end of a sub-segment, a byte offset from the start of video file 150 or other boxes within video file 150 to the start of the sub-segment, and/or a byte length of the sub-segment) for the sub-segments.

In this manner, retrieval unit 52 may retrieve SIDX boxes 162, determine byte ranges and/or playback times for sub-segments of video file 150, and then retrieve the sub-segments individually, based on the determined byte ranges. For example, retrieval unit 52 may submit a first HTTP partial GET request defining a byte range of video file 150 for a first sub-segment, a second HTTP partial GET request defining a byte range of video file 150 for a second sub-segment, and so on. By doing so, retrieval unit 52 may provide data for each sub-segment to video decoder 48. Thus, video decoder 48 may begin decoding video data of the retrieved sub-segment before the entire segment encapsulated by video file 150 has been retrieved. Such may reduce round-trip delay, where the round trip corresponds to the time between submitting a request for media data and the time at which media data has been retrieved and can begin to be decoded and rendered for presentation.

On the other hand, avoiding or skipping the use of SIDX boxes 162 may include simply retrieving data of video file 150 without the use of SIDX boxes 162, whether or not SIDX boxes 162 are present. For example, retrieval unit 52 may simply issue an HTTP GET to retrieve video file 150. In some examples, retrieval unit 52 may first attempt to retrieve a portion of video file 150 corresponding to the expected or estimated location of SIDX boxes 162, but after determining that the retrieved portion does not include SIDX data, sending an HTTP GET request to retrieve video file 150. Alternatively, retrieval unit 52 may submit an HTTP GET request without attempting to determine whether SIDX boxes 162 are present in video file 150.

Accordingly, when retrieval unit 52 determines to use data of SIDX boxes 162, retrieval unit 52 may perform random access (e.g., switch from one representation to another within the same adaptation set, seek to a new temporal location within a representation, or the like) at a sub-segment boundary of a segment encapsulated by video file 150. On the other hand, when retrieval unit 52 determines not to use data of SIDX boxes 162 (e.g., either because there is no or very little value in using SIDX data or because SIDX boxes 162 are not present), retrieval unit 52 may perform random access at a segment boundary of the segment encapsulated by video file 150.

It should be understood that in some cases, where retrieval unit 52 has determined not to use SIDX data of video file 150, retrieval unit 52 may still retrieve SIDX boxes 162. For example, assuming video file 150 includes SIDX boxes 162, but retrieval unit 52 has determined not to use SIDX data of the segment encapsulated by video file 150 (e.g., based on a playback duration of video file 150), retrieval unit 52 may issue an HTTP GET request to retrieve video file 150. Such will inevitably result in the retrieval of SIDX boxes 162, but retrieval unit 52 retrieves data of video file 150 without the use of SIDX boxes 162, in this example. Alternatively, retrieval unit 52 may use HTTP partial GET requests to retrieve data of video file 150 in a piecemeal fashion, but without the assistance of the data of SIDX boxes 162. For instance, retrieval unit 52 may submit HTTP partial GET requests specifying byte ranges of video file 150 that are not based on data of SIDX boxes 162. Both of these cases (submitting a single HTTP GET request or partial GET requests for byte ranges not based on data of SIDX boxes 162) are examples of avoiding or skipping the use of SIDX boxes 162.

In still other examples, retrieval unit 52 may avoid retrieving SIDX boxes 162 entirely after determining not to use SIDX data of the segment encapsulated by video file 150. For instance, after determining not to use SIDX data of the segment, retrieval unit 52 may actively avoid retrieving data of SIDX boxes 162. As an example, retrieval unit 52 may submit an HTTP partial GET request specifying a byte range corresponding to FTYP box 152 and MOOV box 154, and either in the same partial GET request or a different partial GET request, a separate byte range corresponding to movie fragments 164 and MFRA box 166 (assuming MFRA box 166 is present in video file 150). In this manner, retrieval unit 52 may retrieve media data of a segment encapsulated by video file 150 without retrieving SIDX data of the segment (e.g., in response to determining not to use SIDX data of the segment).

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 3). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more IDR and/or ODR pictures. Likewise, MFRA box 166 may provide indications of locations within video file 150 of the IDR and ODR pictures. Accordingly, a temporal sub-sequence of video file 150 may be formed from IDR and ODR pictures of video file 150. The temporal sub-sequence may also include other pictures, such as P-frames and/or B-frames that depend from IDR and/or ODR pictures. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

Moreover, the data may be arranged in a continuous sub-sequence, such that a single byte range may be specified in a partial GET request to retrieve all data of a particular segment used for the temporal sub-sequence. A client device, such as client device 40, may extract a temporal sub-sequence of video file 150 by determining byte-ranges of movie fragments 164 (or portions of movie fragments 164) corresponding to IDR and/or ODR pictures. As discussed in greater detail below, video files such as video file 150 may include a sub-fragment index box and/or a sub-track fragment box, either or both of which may include data for extracting a temporal sub-sequence of video file 150.

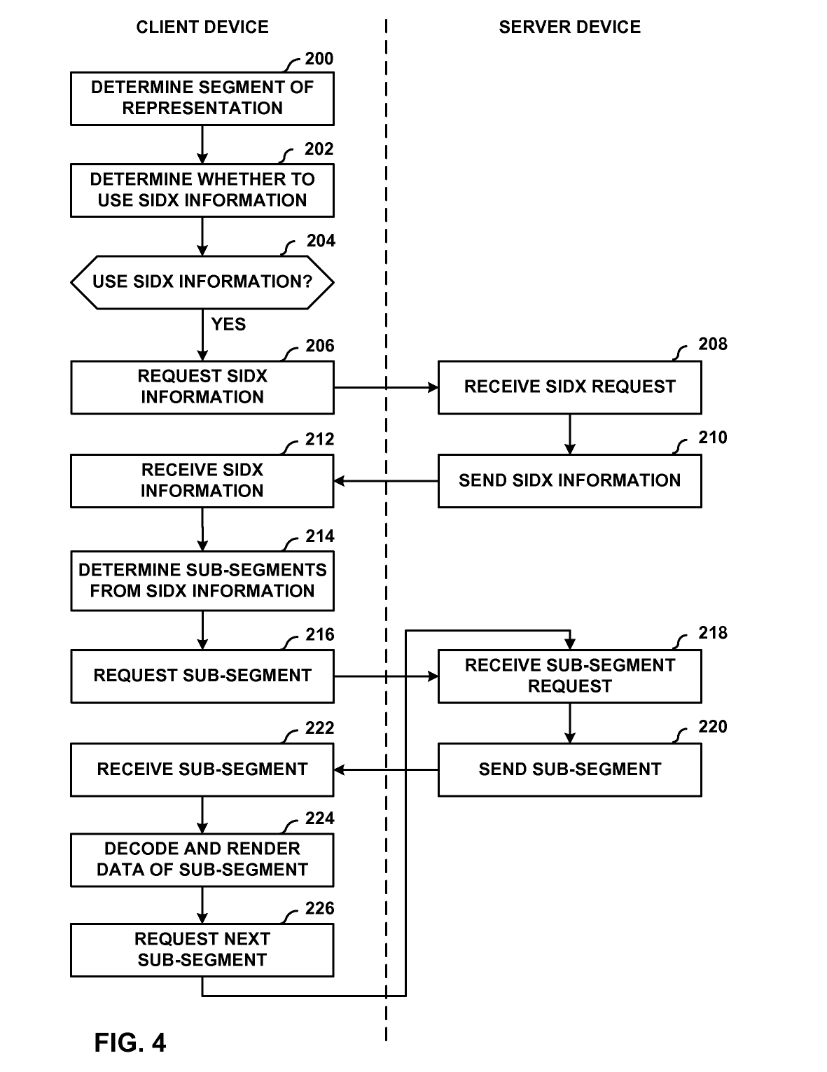

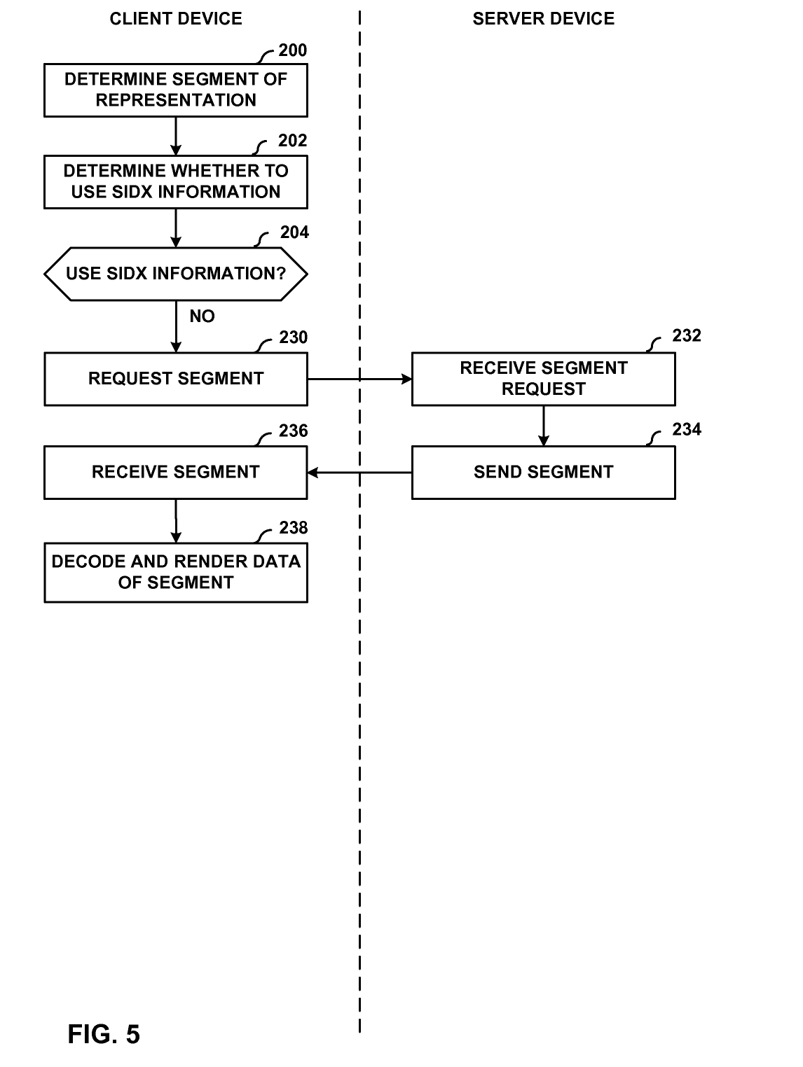

FIGS. 4 and 5 are flowcharts illustrating an example method for retrieving data of a segment in accordance with the techniques of this disclosure. The methods of FIGS. 4 and 5 are described with respect to client device 40 and server device 60 of FIG. 1. However, it should be understood that other devices may be configured to perform these techniques.

Initially, client device 40 may determine an adaptation set, e.g., based on decoding and rendering capabilities of client device 40 (in particular, audio decoder 46 and audio output 42 or video decoder 48 and video output 44). Client device 40 may also select a representation from the adaptation set based on a current estimated amount of available network bandwidth. Client device 40 may then determine a segment of the representation to retrieve (200). In cases where a user initially requests to begin playback from a particular temporal position, client device 40 may select a segment having a SAP with a starting playback position that is closest to the user's requested position. Otherwise, when beginning playback from the beginning of the representation, client device 40 may select an ordinal first segment of the representation.

In any case, client device 40 may then determine whether to use SIDX information of the segment when retrieving data of the segment (202, 204). FIG. 4 illustrates an example method for when client device 40 determines to use SIDX information (“YES” branch of 204), whereas FIG. 5 illustrates an example method for when client device 40 determines not to use SIDX information. In some examples, client device 40 may determine whether to use SIDX information based on whether the determined segment includes SIDX information, and only uses the SIDX information when the segment includes the SIDX information. In some examples, in addition to or in the alternative to the examples previously described, client device 40 determines whether to use SIDX information based on a playback duration of the segment, e.g., by comparing the playback duration of the segment to a threshold.

In the case where client device 40 determines to use SIDX information, client device 40 may request SIDX information for the segment from server device 60 (FIG. 4, 206). For example, client device 40 may determine an estimated byte-wise location of the SIDX information within the segment, e.g., based on heuristic testing or configuration data. Client device 40 may then construct an HTTP partial GET request that specifies a URL for the segment and a byte range for the estimated location of the SIDX information. It should be understood that in some examples, the determination of whether to use the SIDX information may include actually retrieving SIDX information, in which case client device 40 may simply use the SIDX information already retrieved, request only any additional SIDX information that was not already retrieved, or re-request all of the SIDX information.

Server device 60 may then receive the request (208) and send the requested data (i.e., the SIDX information) to client device 40 (210). Client device 40 may subsequently receive the SIDX information (212). As discussed above, the SIDX information may specify byte range data for sub-segments of the segment, playback time data for the sub-segments, whether the sub-segments begin with a SAP, and the like. Thus, client device 40 may determine sub-segments of the segment from the SIDX information (214). In some examples, the SIDX information may specify any or all of starting bytes for the sub-segments, ending bytes for the sub-segments, byte lengths of the sub-segments, byte offsets to the start and/or end of the sub-segments, or the like.

Thus, using the SIDX information, client device 40 may request a sub-segment of the segment from server device 60 (216). For example, client device 40 may determine a starting byte and an ending byte of a first sub-segment of the segment using the SIDX information. Then, client device 40 may construct an HTTP partial GET request specifying a URL of the segment and a byte range defined by the determined starting byte and ending byte, and send the partial GET request to server device 60. Server device 60 may then receive the sub-segment request from client device 40 (218) and send the requested sub-segment to client device 40 (220).

Client device 40 may then receive the requested sub-segment (222) and decode and render data of the sub-segment (224). While data of the sub-segment is being decoded and/or rendered, or while data of the sub-segment is buffered and awaiting decoding/rendering, client device 40 may request a next sub-segment of the segment 226). In this manner, client device 40 may use the SIDX information in cases where the SIDX information is determined to be beneficial, which may reduce round-trip delay. That is, client device 40 may decode and render data of the first sub-segment before receiving all of the data of the segment that includes the sub-segment.

FIG. 5 illustrates an example of the method in the case that client device 40 determines not to use the SIDX information (“NO” branch of 204). For instance, client device 40 may determine that the segment does not include SIDX information, or client device 40 may determine that the playback duration is sufficiently short (e.g., below or equal to a threshold) that using SIDX information would not be beneficial. In this example, client device 40 may simply request the segment (230), e.g., using an HTTP GET request specifying a URL for the segment, from server device 60. Server device 60 may receive the segment request (232) and send the segment to client device 40 (234). Client device 40 may then receive the segment (236) and decode and render data of the segment (238).

It should be understood that in cases where client device 40 determines not to use SIDX information of a segment, client device 40 may still receive the SIDX information, but not use the SIDX information to retrieve data of the segment. Alternatively, in some examples, client device 40 may avoid retrieving the SIDX information, e.g., through use of partial GET requests that avoid a byte range corresponding to the SIDX information, in response to determining not to use the SIDX information.

Client device 40 may perform the method of FIGS. 4 and 5 in response to a random access event. For instance, client device 40 may perform the method of FIGS. 4 and 5 after determining to switch between representations of an adaptation set, and/or in response to a user requesting to seek to a different temporal location within the adaptation set. Moreover, after determining that a segment does not include SIDX data, client device 40 may enter a no-SIDX-present mode, in which client device 40 does not later attempt to use SIDX information of other segments. However, when in the no-SIDX present mode, client device 40 may determine whether subsequent segments include SIDX information, and when a subsequent segment includes SIDX information, client device 40 may enter a SIDX-present mode, in which client device 40 may use SIDX information.

In this manner, the method of FIGS. 4 and 5 represent an example of a method including determining, for a segment of a representation of media data, whether to use segment index (SIDX) information of the segment, and in response to determining not to use the SIDX information, retrieving media data of the segment without using the SIDX information of the segment.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of retrieving media data, the method comprising:
determining, for a segment of a representation of media data, whether to use segment index (SIDX) information of the segment; and
in response to determining not to use the SIDX information, retrieving media data of the segment without using the SIDX information of the segment.

2. The method of claim 1, further comprising, in response to determining to use the SIDX information:
retrieving the SIDX information; and
retrieving one or more sub-segments of the segment using the SIDX information.

3. The method of claim 2, wherein retrieving the one or more sub-segments comprises pipelining requests for the one or more segments.

4. The method of claim 1, wherein determining whether to use the SIDX information comprises:
determining whether a playback duration of the segment is below a threshold;
when the playback duration is below or equal to the threshold, determining not to retrieve the SIDX information; and
when the playback duration is above the threshold, determining to retrieve the SIDX information.

5. The method of claim 4, wherein the threshold is within a range of one half of one second to ten seconds.

6. The method of claim 1, wherein determining whether to use the SIDX information comprises determining whether the segment includes the SIDX information, comprising:
retrieving a portion of the segment corresponding to an estimated location of a SIDX box in the segment;
determining whether the retrieved portion of the segment includes the SIDX information;
when the retrieved portion includes the SIDX information, determining that the segment includes the SIDX information; and
when the retrieved portion does not include the SIDX information, determining that the segment does not include the SIDX information.

7. The method of claim 6, further comprising:
when the segment includes the SIDX information, determining to use the SIDX information; and
when the segment does not include the SIDX information, determining not to use the SIDX information.

8. The method of claim 6, further comprising:
in response to determining that the segment does not include the SIDX information, entering a no-SIDX-present mode in which SIDX is not used; and
in response to determining that a subsequent segment of the representation includes SIDX information, entering a SIDX-present mode in which SIDX information is used.

9. The method of claim 8, further comprising, in response to a random access event to access a different segment:
entering the SIDX-present mode and requesting SIDX information of the different segment; and
in response to receiving the SIDX information of the different segment, requesting to retrieve one or more sub-segments of the different segment based on the SIDX information of the different segment.

10. The method of claim 1, wherein the representation comprises a second representation, the method further comprising:
retrieving media data of a first representation, wherein the second representation is different than the first representation, wherein the first representation has a first bitrate, and wherein the second representation has a second bitrate;
after retrieving the media data of the first representation, determining that an available amount of network bandwidth has changed;
selecting the second representation based on the second bitrate and the available amount of network bandwidth;
in response to determining not to use the SIDX information and based on the selection of the second representation, switching to the second representation at a segment boundary of the segment of the second representation; and
in response to determining to use the SIDX information and based on the selection of the second representation, switching to the second representation at a sub-segment boundary of the segment of the second representation.

11. The method of claim 1, wherein retrieving media data of the segment in response to determining not to use the SIDX information comprises retrieving the entire segment.

12. The method of claim 1, wherein retrieving media data of the segment in response to determining not to use the SIDX information comprises retrieving the segment without retrieving the SIDX information of the segment.

13. A device for retrieving media data, the device comprising one or more processors configured to determine, for a segment of a representation of media data, whether to use segment index (SIDX) information of the segment, and in response to determining not to use the SIDX information, retrieve media data of the segment without using the SIDX information of the segment.

14. The device of claim 13, wherein the one or more processors are further configured to, in response to determining to use the SIDX information, retrieve the SIDX information, retrieve one or more sub-segments of the segment using the SIDX information, and pipeline requests for the one or more sub-segments in response to determining to use the SIDX information.

15. The device of claim 13, wherein to determine whether to use the SIDX information, the one or more processors are configured to determine whether a playback duration of the segment is below a threshold, when the playback duration is below or equal to the threshold, determine not to retrieve the SIDX information, and when the playback duration is above the threshold, determine to retrieve the SIDX information.

16. The device of claim 13, wherein the one or more processors are configured to retrieve a portion of the segment corresponding to an estimated location of a SIDX box in the segment, determine whether the retrieved portion of the segment includes the SIDX information, when the retrieved portion includes the SIDX information, determine that the segment includes the SIDX information, and when the retrieved portion does not include the SIDX information, determine that the segment does not include the SIDX information.

17. The device of claim 16, wherein the one or more processors are further configured to determine to use the SIDX information when the segment includes the SIDX information, to determine not to use the SIDX information when the segment does not include the SIDX information, to enter a no-SIDX-present mode in which SIDX is not used in response to determining that the segment does not include the SIDX information, and to enter a SIDX-present mode in which SIDX information is used in response to determining that a subsequent segment of the representation includes SIDX information.

18. The device of claim 17, wherein the one or more processors are configured to, in response to a random access event to access a different segment, enter the SIDX-present mode, request SIDX information of the different segment, and in response to receiving the SIDX information of the different segment, request to retrieve one or more sub-segments of the different segment based on the SIDX information of the different segment.

19. The device of claim 13, wherein the device comprises at least one of:
an integrated circuit;
a microprocessor; and
a wireless communication device.

20. A computer-readable storage medium having stored thereon instructions that, when executed, cause a processor to:
determine, for a segment of a representation of media data, whether to use segment index (SIDX) information of the segment; and
in response to determining not to use the SIDX information, retrieve media data of the segment without using the SIDX information of the segment.
